(19) United States
(12) Patent Application Publication
(10) Pub. No.: US 2021/0266418 A1
(43) Pub. Date: Aug. 26, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Akihiro ISHII, Kanagawa (JP); Hiroyuki MITSUHASHI, Kanagawa (JP); Yusuke TAGUCHI, Kanagawa (JP); Shuhei TODA, Kanagawa (JP); Yohei MAKINO, Kanagawa (JP)

(73) Assignee: FUJI XEROX CO., LTD., Tokyo (JP)

(21) Appl. No.: 17/060,480

(22) Filed: Oct. 1, 2020

(30) Foreign Application Priority Data
Feb. 20, 2020 (JP) 2020-027104

(51) Int. Cl. H04N 1/00

(52) U.S. Cl. CPC H04N 1/00514; H04N 1/00477; H04N 1/00323

(57) ABSTRACT

An information processing apparatus includes a processor. The processor is configured to acquire biological information on a user, and output information that indicates a content of a process performed in accordance with an operation by the user in a case where the biological information indicates an anxious psychological state when the process is completed.

### Cross-Reference to Related Applications

This application is based on and claims priority under 35 USC 119 from Japanese Patent Application No. 2020-027104 filed Feb. 20, 2020.

### BACKGROUND

### (i) Technical Field

The present disclosure relates to an information processing apparatus and a non-transitory computer readable medium.

### (ii) Related Art

There is known a technique of performing a process that matches the psychological state of a user. Japanese Unexamined Patent Application Publication No. 2017-94679, for example, describes displaying, on an operation panel section, an operation screen for stopping a job in the case where a user is in a “tensed state” during execution of the job. Japanese Unexamined Patent Application Publication No. 2017-229035 describes determining the state of a user on the basis of biological information on the user when executing a transmission job, and executing a confirmation request process for requesting a confirmation about the transmission job from the user in the case where the user is in a non-normal state.

### SUMMARY

After a process performed in accordance with an operation by the user is completed, the user occasionally feels anxious that a process with a wrong content is performed, for example.

Aspects of non-limiting embodiments of the present disclosure relate to allowing a user to confirm the content of a process in the case where the user is feeling anxious after the process is completed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor, in which the processor is configured to acquire biological information on a user, and output information that indicates a content of a process performed in accordance with an operation by the user in a case where the biological information indicates an anxious psychological state when the process is completed.

### BRIEF DESCRIPTION OF THE DRAWINGS

An exemplary embodiment of the present disclosure will be described in detail based on the following figures, wherein:

FIG. 1 illustrates an example of the configuration of an image processing system according to an exemplary embodiment;

FIG. 2 illustrates an example of the configuration of an image processing apparatus;

FIG. 3 is a sequence chart illustrating an example of operation performed by the image processing system;

FIG. 4 illustrates an example of screen transitions in a facsimile process;

FIG. 5 illustrates an example of a transmission report;

FIG. 6 illustrates an example of screen transitions in a setting change process; and

FIG. 7 illustrates an example of a confirmation screen.

### DETAILED DESCRIPTION

### 1. Configuration

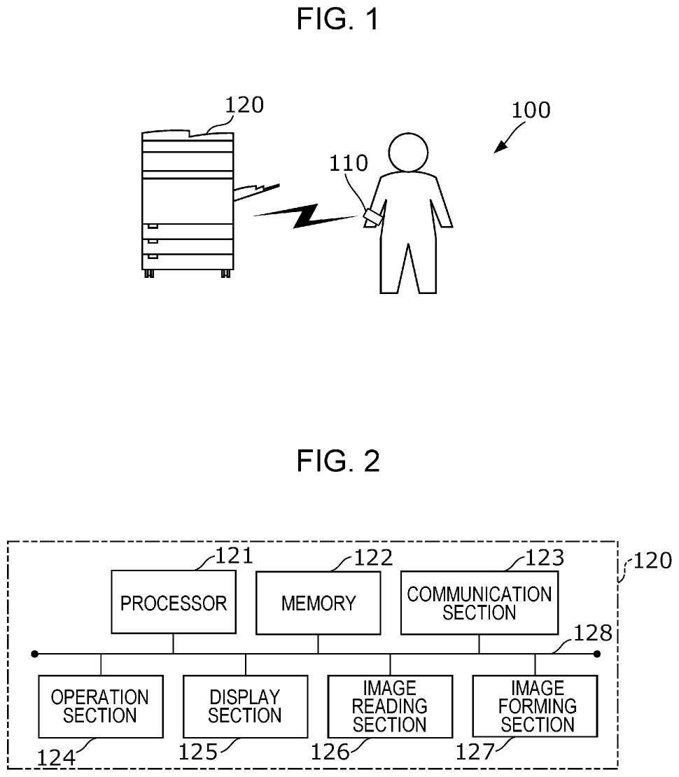

FIG. 1 illustrates an example of the configuration of an image processing system 100 according to the present exemplary embodiment. In the image processing system 100, a process is executed in accordance with an operation by a user. At this time, for some processes, the result of the process is not clearly seen, and the user occasionally feels anxious that a process with a desired content is performed. Thus, the image processing system 100 provides information that indicates the content of a process to the user in the case where the user is feeling anxious after the process is completed, in order to relieve his/her anxiety. The state of feeling anxious is an example of the anxious psychological state according to the present disclosure. The “anxious psychological state” refers to a state in which the user has an apprehension. Examples of the anxious psychological state include a psychological state with a worry or a concern, a restless psychological state, and a stressed psychological state. The image processing system 100 includes a wearable terminal 110 and an image processing apparatus 120. The image processing apparatus 120 is an example of the information processing apparatus according to the present disclosure.

The wearable terminal 110 is mounted to the user, and measures biological information on the user. The biological information indicates whether or not the user is feeling anxious. The wearable terminal 110 has the shape of a wristband mounted to an arm, for example, as illustrated in FIG. 1. However, the shape of the wearable terminal 110 is not limited to a wristband shape. For example, the shape of the wearable terminal 110 may be any shape such as the shape of a ring mounted to a finger, the shape of a clip attached to a garment, the shape of glasses mounted to the head, and a head-mount type. The wearable terminal 110 includes one or a plurality of sensors (not illustrated) that measure biological information. The biological information includes a heart rate or a blood pressure, for example. In the case where the biological information includes a heart rate, for example, the wearable terminal 110 includes a heart rate meter that measures the heart rate. In the case where the biological information includes a blood pressure, the wearable terminal 110 includes a sphygmomanometer that measures the blood pressure. The wearable terminal 110 also includes a communication section (not illustrated). The communication section performs data communication with a different device in accordance with Bluetooth (registered trademark), for example. However, the communication standard which is employed by the communication section is not limited to Bluetooth (registered trademark), and may be a different communication standard. The wearable terminal 110 transmits the biological information from the communication section to the image processing apparatus 120, for example.

FIG. 2 illustrates an example of the configuration of the image processing apparatus 120. The image processing apparatus 120 has a plurality of functions to process an image, such as a copy function, a print function, a scan function, and a facsimile function. The image processing apparatus 120 performs a process that implements such functions in accordance with an operation by the user. The image processing apparatus 120 includes a processor 121, a memory 122, a communication section 123, an operation section 124, a display section 125, an image reading section 126, and an image forming section 127. Such sections are connected to each other via a bus 128.

The processor 121 controls the various sections of the image processing apparatus 120 or performs various processes by executing a program. The processor 121 is a central processing unit (CPU), for example. The memory 122 stores a program to be executed by the processor 121. The memory 122 is a read only memory (ROM) and a random access memory (RAM), for example. The memory 122 may also be a hard disk drive or a solid state drive (SSD), for example, in addition to the ROM and the RAM. The communication section 123 performs data communication with a different device connected via a communication line. The communication line may be a wired communication line, or may be a wireless communication line. Examples of the communication standard which is employed by the communication section 123 include Bluetooth (registered trademark). The operation section 124 is used by the user to operate the image processing apparatus 120. Examples of the operation section 124 include a touch screen and buttons. The display section 125 displays various types of information. The display section 125 is a liquid crystal display, for example. The image reading section 126 reads an image, and converts the image into image data. The image reading section 126 is an image scanner, for example. The image forming section 127 forms an image that matches image data on a medium such as paper. The image forming section 127 is a printer, for example.

### 2. Operation

In the case where the processor 121 is indicated as the subject of a process in the following description, it is meant that the process is performed by the processor 121 performing computation or controlling operation of other hardware elements through cooperation of the program which is stored in the memory 122 and the processor 121 which executes the program.

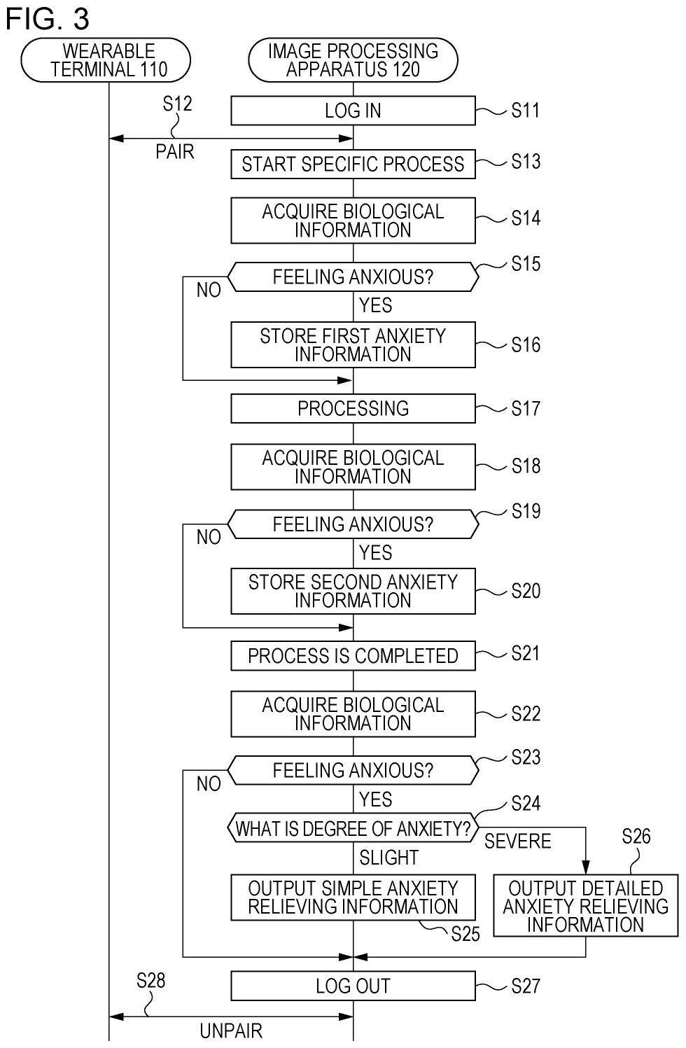

FIG. 3 is a sequence chart illustrating an example of operation performed by the image processing system 100. This operation is performed when the user utilizes the image processing apparatus 120. In step S11, the user logs in to the image processing apparatus 120. The processor 121 of the image processing apparatus 120 authenticates the user who has logged in. The user performs an operation to input his/her user ID and password using the operation section 124. The processor 121 authenticates the user using the user ID and the password which are input by the user. When the user is successfully authenticated, the process proceeds to step S12. In the case where the user is not successfully authenticated, the process is ended.

In step S12, the processor 121 pairs the image processing apparatus 120 with the wearable terminal 110 of the user. At this time, first, the wearable terminal 110 of the user is specified. For example, the user ID of the user is correlated with a terminal ID of the wearable terminal 110 of the user in advance. A terminal ID correlated with the user ID which is input in step S11 is specified, and the wearable terminal 110 corresponding to the specified terminal ID is specified as the wearable terminal 110 of the user. Subsequently, the image processing apparatus 120 is paired with the specified wearable terminal 110 in accordance with Bluetooth (registered trademark). Consequently, the image processing apparatus 120 and the wearable terminal 110 of the user are wirelessly connected to each other. While the image processing apparatus 120 is paired with one wearable terminal 110, the image processing apparatus 120 is not paired with a different wearable terminal 110.

In step S13, the processor 121 starts a specific process in accordance with an operation by the user. The “specific process” refers to a process, the result of which is not easily clearly seeable. Examples of the specific process include a facsimile process and a setting change process. The facsimile process is a process of transmitting a facsimile to a transmission destination. When the facsimile process is completed, it is seen that a facsimile has been transmitted, but it is not seen whether the facsimile has been delivered to the correct transmission destination. The setting change process is a process of changing the setting for a process for each user in accordance with the preference of the user or the usability. When the setting for a process is changed through the setting change process, an operation image corresponding to the setting after the change is displayed on a menu screen, for example. The process is performed in accordance with the setting after the change by performing an operation using the operation image. Alternatively, when the setting for a process is changed through the setting change process, the setting after the change may be used as default setting for the user. The setting after the change includes one or a plurality of setting values. When the setting change process is completed, it is seen that the setting has been changed, but the setting value after the change is not seen. In the case where a process other than the specific process is started, the processes in steps S14 to S16, S18 to S20, and S22 to S26 to be discussed later are not performed.

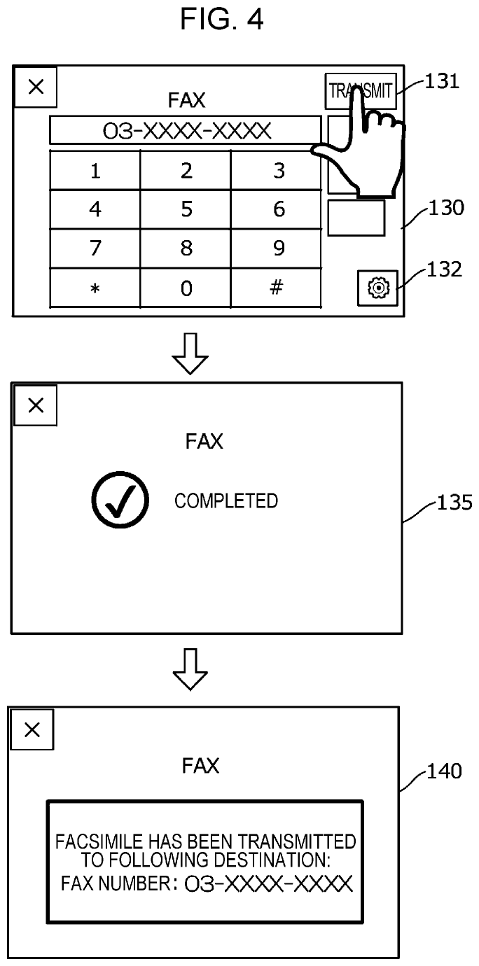

FIG. 4 illustrates an example of screen transitions in the facsimile process. In the case where the facsimile process is to be performed, a facsimile screen 130 is displayed on the display section 125. The user performs an operation to designate a facsimile number that indicates a transmission destination on the facsimile screen 130, and thereafter performs an operation to press a transmit button 131. When the transmit button 131 is pressed, transmission of a facsimile to the transmission destination indicated by the facsimile number is started.

In step S14, the processor 121 acquires biological information from the wearable terminal 110 when the specific process is started. In the case where the facsimile process is started in step S13 discussed above, for example, biological information is acquired when the transmit button 131 illustrated in FIG. 4 is depressed. Specifically, the processor 121 transmits, from the communication section 123, a request to acquire biological information to the wearable terminal 110 which is paired in step S12. The wearable terminal 110 transmits biological information measured from the user to the image processing apparatus 120 in response to this acquisition request. The wearable terminal 110 receives, at the communication section 123, the biological information which is transmitted from the wearable terminal 110.

In step S15, the processor 121 determines whether or not the user is feeling anxious when the process is started by analyzing the biological information which is acquired in step S14. This determination is made in accordance with whether or not the biological information indicates that the user is feeling anxious. In the case where the biological information includes a heart rate or a blood pressure, for example, it is determined that the user is feeling anxious when the heart rate or the blood pressure is equal to or more than a threshold value. The threshold value is set in advance to a minimum value of the heart rate or the blood pressure measured when a person is feeling anxious, for example. In the case where it is determined that the user is not feeling anxious, the determination in step S15 is NO, and the process proceeds to step S17 by skipping the process in step S16. In the case where it is determined that the user is feeling anxious, on the other hand, the determination in step S15 is YES, and the process proceeds to step S16. In step S16, the processor 121 causes the memory 122 to store first anxiety information indicating that the user is feeling anxious when the process is started.

While the specific process is performed in step S17, the processor 121 acquires biological information from the wearable terminal 110 in step S18, as in step S14 discussed above. In the case where the facsimile process is started in step S13 discussed above, for example, biological information is acquired while a facsimile is transmitted to the transmission destination.

In step S19, the processor 121 determines whether or not the user is feeling anxious during the specific process by analyzing the biological information which is acquired in step S18, as in step S15 discussed above. In the case where it is determined that the user is not feeling anxious, the determination in step S19 is NO, and the process proceeds to step S21 by skipping the process in step S20. In the case where it is determined that the user is feeling anxious, on the other hand, the determination in step S19 is YES, and the process proceeds to step S20. In step S20, the processor 121 causes the memory 122 to store second anxiety information indicating that the user is feeling anxious during the specific process.

When the specific process is completed in step S21, the processor 121 acquires biological information from the wearable terminal 110 in step S22, as in step S14 discussed above. In the case where the facsimile process is started in step S13 discussed above, for example, a completion screen 135 illustrated in FIG. 4 is displayed on the display section 125 when the facsimile process is completed. Then, biological information is acquired when the facsimile process is completed.

In step S23, the processor 121 determines whether or not the user is feeling anxious when the specific process is completed by analyzing the biological information which is acquired in step S22, as in step S15 discussed above. In the case where it is determined that the user is not feeling anxious, the determination in step S23 is NO, and the process proceeds to step S27 by skipping the processes in steps S24 and S25. In the case where it is determined that the user is feeling anxious, on the other hand, the determination in step S23 is YES, and the process proceeds to step S24.

In step S24, the processor 121 determines the degree of anxiety of the user. The degree of anxiety includes a slight degree and a severe degree. The slight degree of anxiety is an example of the slight anxious state according to the present disclosure. The severe degree of anxiety is an example of the severe anxious state according to the present disclosure. The slight anxious state and the severe anxious state differ from each other in the severity of anxiety. The severe anxious state refers to a state in which the user is feeling more anxious than in the slight anxious state. In other words, the slight anxious state refers to a state in which the user is feeling less anxious than in the severe anxious state. The degree of anxiety is determined in accordance with the length of the period for which the user is feeling anxious, for example. In the case where the memory 122 does not store the first anxiety information or the second anxiety information, for example, it is indicated that the user is not feeling anxious when the specific process is started or during the specific process, but that the user is feeling anxious after the specific process is completed. In this case, the period for which the user is feeling anxious is short, and therefore it is determined that the degree of anxiety of the user is slight. On the other hand, in the case where the memory 122 stores at least one of the first anxiety information and the second anxiety information, for example, it is indicated that the user is feeling anxious not only after the specific process is completed, but also at least one of when the specific process is started and during the specific process. In this case, the period for which the user is feeling anxious is long, and therefore it is determined that the degree of anxiety of the user is severe. In the case where it is determined in step S24 that the degree of anxiety is slight, the process proceeds to step S25.

In step S25, the processor 121 outputs simple anxiety relieving information that indicates the content of the specific process, which is completed in step S21, in order to relieve the anxiety of the user. The simple anxiety relieving information is an example of the first information according to the present disclosure. In the case where the facsimile process is completed in step S21, for example, a confirmation screen 140 including the simple anxiety relieving information is displayed on the display section 125 as illustrated in FIG. 4. In the example illustrated in FIG. 4, the confirmation screen 140 includes a facsimile number that indicates the transmission destination of the facsimile as the anxiety relieving information. The user is able to see the transmission destination of the facsimile by looking at the confirmation screen 140.

In the case where it is determined in step S24 discussed above that the degree of anxiety is severe, on the other hand, the process proceeds to step S26. In step S26, the processor 121 outputs detailed anxiety relieving information that indicates the content of the process which is completed in step S21, in order to relieve the anxiety of the user. In this manner, different anxiety relieving information is output in accordance with the degree of anxiety of the user. The detailed anxiety relieving information is an example of the second information according to the present disclosure.

The detailed anxiety relieving information contains a larger amount of information than the simple anxiety relieving information. The detailed anxiety relieving information may include the simple anxiety relieving information, may partially overlap the simple anxiety relieving information, or may be different from the simple anxiety relieving information. That is, the phrase “contain a larger amount of information” as used herein may indicate a state in which the detailed anxiety relieving information contains additional information in addition to the simple anxiety relieving information, or may simply indicate a state in which the detailed anxiety relieving information contains more information such as characters and images than the simple anxiety relieving information. In the case where the facsimile process is completed in step S21, for example, a transmission report 150 that includes the detailed anxiety relieving information is output.

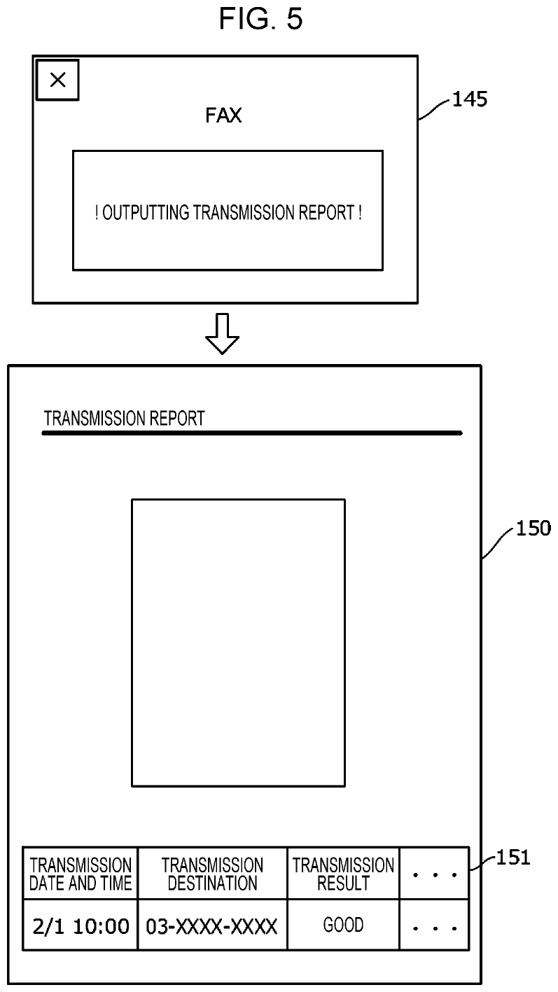

FIG. 5 illustrates an example of the transmission report 150. Before outputting the transmission report 150, a notification screen 145 indicating that the transmission report 150 is to be output is displayed on the display section 125 as illustrated in FIG. 5. Then, the transmission report 150 is prepared, and printed by the image forming section 127. In the example illustrated in FIG. 5, the transmission report 150 includes, as the detailed anxiety relieving information, a facsimile number that indicates the transmission destination of the facsimile, the date and time of transmission of the facsimile, and the transmission result. The user is able to see the date and time of transmission of the facsimile and the transmission result, in addition to the transmission destination of the facsimile, by looking at the transmission report 150.

When the user logs out from the image processing apparatus 120 in step S27, the processor 121 unpairs the image processing apparatus 120 from the wearable terminal 110 in step S28.

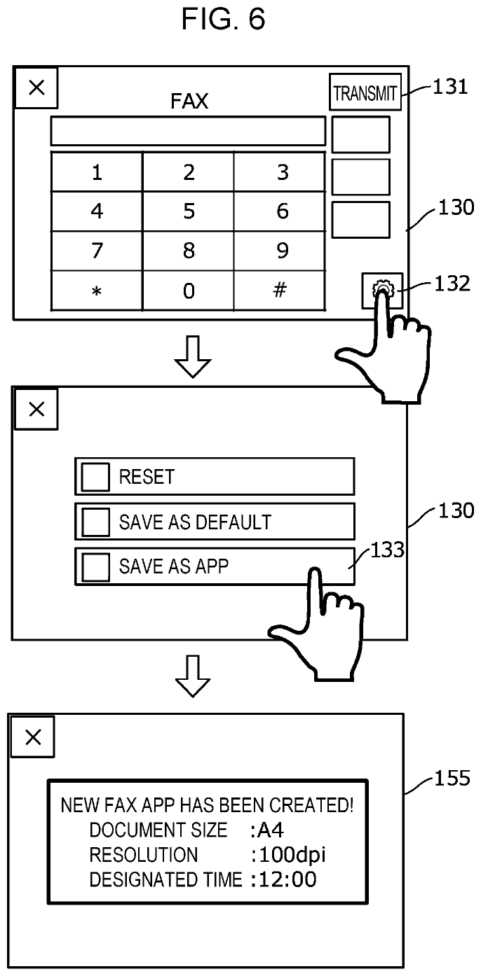

Next, an example of a case where the setting change process is started in step S13 discussed above will be described. FIG. 6 illustrates an example of screen transitions in the setting change process. In the case where setting for the facsimile process is to be changed, the user performs an operation to press a set button 132 included in the facsimile screen 130. Biological information is acquired in step S14 when the set button 132 is depressed. When the set button 132 is pressed, a setting change screen is displayed on the display section 125. The user performs an operation to change setting for the facsimile process on the setting change screen. For example, the resolution of the facsimile process is changed from 200 dots per inch (dpi) to 100 dpi. The setting change process is treated as being performed during a period for which an operation to change setting is performed. Therefore, biological information is acquired in step S18 while this operation is performed. When the operation to change setting is completed, a save button 133 is displayed on the display section 125 as illustrated in FIG. 6. When the user performs an operation to press the save button 133, the setting change process is completed. Biological information is acquired in step S22 when the save button 133 is depressed. When the save button 133 is pressed, in addition, setting values included in the setting after the change are stored in the memory 122 in association with the user ID, and an operation image corresponding to the setting after the change is generated and displayed on the menu screen for the user, for example. The process is performed in accordance with the setting after the change by performing an operation using the operation image the next time.

In the case where it is determined in step S24 discussed above that the degree of anxiety is slight, a confirmation screen 155 including the simple anxiety relieving information is displayed on the display section 125 as illustrated in FIG. 6. In the example illustrated in FIG. 6, the confirmation screen 155 includes setting values included in the setting after the change as the simple anxiety relieving information. In the case where the document size, the resolution, and the designated time are changed to A4, 100 dpi, and 12:00, respectively, in setting for the facsimile process, for example, the confirmation screen 155 includes such setting values. In this manner, the simple anxiety relieving information includes information that indicates the result of the process. The user is able to see setting values included in the setting after the change on the confirmation screen 155.

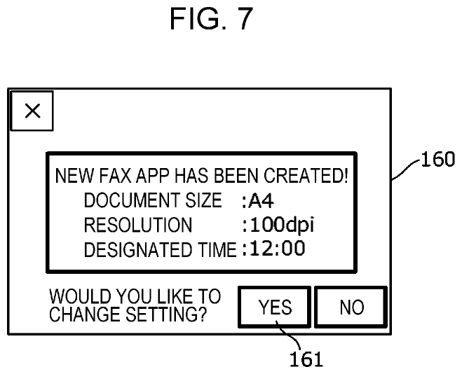

In the case where it is determined in step S24 discussed above that the degree of anxiety is severe, on the other hand, a confirmation screen 160 including the detailed anxiety relieving information is displayed on the display section 125. FIG. 7 illustrates an example of the confirmation screen 160. In the example illustrated in FIG. 7, the confirmation screen 160 includes setting values included in the setting after the change and a change button 161 as the detailed anxiety relieving information. The change button 161 is an example of the operation image according to the present disclosure. To further change the setting, the user performs an operation to press the change button 161. When the change button 161 is pressed, a setting change screen is displayed on the display section 125 to allow the user to perform an operation to further change the setting.

### 3. Modifications

The exemplary embodiment discussed above is an example of the present disclosure. The present disclosure is not limited to the exemplary embodiment discussed above. The exemplary embodiment discussed above may be modified as in the following examples to be implemented. Two or more of the following modifications may be combined with each other.

In the exemplary embodiment discussed above, anxiety relieving information that indicates the content of a process may not be output in the case where biological information indicates an anxious psychological state before the specific process is completed. For example, anxiety relieving information may not be output, even if it is determined that the user is feeling anxious after the specific process is completed, in the case where at least one of the first anxiety information and the second anxiety information is stored in the memory 122. This is because it is considered that the user is feeling anxious irrespective of his/her own operation related to the specific process in the case where the user is feeling anxious also before the specific process is completed, and therefore it is occasionally not convenient to the user, but is rather annoying, to output anxiety relieving information. With this modification, anxiety relieving information that indicates the content of a process is not output in the case where the user is feeling anxious also before the process is completed.

In the exemplary embodiment discussed above, the number of times when biological information is acquired is not limited to three. For example, acquisition of biological information may be started when the specific process is started, biological information may be repeatedly acquired at determined time intervals during the specific process, and acquisition of biological information may be finished when the specific process is completed. In this case, it may be determined whether or not the user is feeling anxious each time biological information is acquired. On the other hand, it may not be determined whether or not the user is feeling anxious each time biological information is acquired. For example, when biological information is acquired, the acquired biological information and the date and time of the acquisition may be stored in the memory 122, and it may be collectively determined after the process is completed whether the user is feeling anxious and, in the case where the user is feeling anxious, whether the degree of the anxiety is slight or severe on the basis of the biological information which is stored in the memory 122 and the date and time of the acquisition.

In the exemplary embodiment discussed above, the degree of anxiety may not necessarily be determined. When the memory 122 stores first anxiety information and does not store second anxiety information in the case where the user is feeling anxious after the facsimile process is completed, it is considered that the user is feeling anxious about an operation to designate the transmission destination of a facsimile when the facsimile process is started. In this case, the confirmation screen 140 illustrated in FIG. 4 may be displayed. Since the confirmation screen 140 includes a facsimile number that indicates the transmission destination, the user is able to see if the transmission destination is correct on the confirmation screen 140. When the memory 122 stores second anxiety information and does not store first anxiety information in the case where the user is feeling anxious after the facsimile process is completed, on the other hand, it is considered that the user is feeling anxious about whether a facsimile is delivered to the transmission destination while the facsimile is transmitted. In this case, the transmission report 150 illustrated in FIG. 5 may be output. Since the transmission report 150 includes the transmission result, the user is able to see if the facsimile is delivered to the transmission destination from the transmission report 150. In this manner, anxiety relieving information may be different in accordance with the time when the user feels anxious.

In the exemplary embodiment discussed above, the index for determining the degree of anxiety of the user is not limited to the length of the period for which the user is feeling anxious. For example, this index may be the intensity of the biological information. In the case where the biological information includes a heart rate or a blood pressure, for example, it may be determined that the degree of anxiety is severe when the heart rate or the blood pressure acquired after the process is completed is equal to or more than a first threshold value. Meanwhile, it may be determined that the degree of anxiety is slight when the heart rate or the blood pressure is equal to or more than a second threshold value, which is less than the first threshold value, and less than the first threshold value.

In the exemplary embodiment discussed above, biological information may not necessarily be acquired when the specific process is started and during the specific process. For example, biological information may be acquired only after the specific process is completed. In this case, the degree of anxiety of the user may be determined using the intensity of the biological information as the index as in the modification discussed above, for example.

In the exemplary embodiment discussed above, the specific process is not limited to the facsimile process and the setting change process. For example, the specific process may include any process of transmitting information to a transmission destination. Examples of the specific process may include a process of transmitting an image obtained through scanning to a transmission destination via electronic mail, a process of transmitting an electronic mail, and a process of uploading a file. The specific process may be any process, the result of which is not easily clearly seeable.

In the exemplary embodiment discussed above, biological information may be acquired when the user logs in. In this case, it is determined on the basis of this biological information whether or not the user is feeling anxious. In the case where it is determined that the user is feeling anxious also at the time of log-in, it is considered that the user is feeling anxious irrespective of the process. Thus, in this case, anxiety relieving information may not be output even if it is determined that the user is feeling anxious when the process is completed.

In the exemplary embodiment discussed above, the manner of display may be changed for a process, for which it is determined that the user is feeling anxious, in order to relieve the anxiety of the user when the user performs the process the next time. For example, in the case where it is determined that the user is feeling anxious when the facsimile process is completed, a designated facsimile number that indicates the transmission destination of a facsimile may be displayed as highlighted when the user performs an operation to designate the facsimile number in order to perform the facsimile process the next time. Examples of the highlighted display include a change in the color, a change in the size, and a change in the display position. For example, the facsimile number may be displayed in a more distinct color than the other information, may be displayed in a larger size than the other information, or may be displayed at a more noticeable position than the other information.

In the exemplary embodiment discussed above, in the case where the user is not authenticated by the image processing apparatus 120, the processor 121 may detect the wearable terminal 110 that is the closest to the image processing apparatus 120 at the timing when the user uses the image processing apparatus 120, and pair the image processing apparatus 120 with the detected wearable terminal 110. This timing may be the time when the image processing apparatus 120 returns from a power-saving mode in the case where the image processing apparatus 120 has a power-saving mode, or may be the time when the image processing apparatus 120 is started, for example. In this case, in addition, the processor 121 may unpair the image processing apparatus 120 from the wearable terminal 110 at the timing when the user does not use the image processing apparatus 120 any more. This timing may be the time when the image processing apparatus 120 transitions to a power-saving mode in the case where the image processing apparatus 120 has a power-saving mode, for example.

In the exemplary embodiment discussed above, a different information processing apparatus may be used in place of the image processing apparatus 120. For example, the information processing apparatus may include any information processing apparatus such as a home electric appliance, an audio device, and a computer. The process performed by the information processing apparatus is not limited to a process in which an images is used. The process performed by the information processing apparatus may be any process performed in accordance with an operation by the user.

The subjects of the processes in the image processing system 100 according to the exemplary embodiment discussed above are exemplary, and are not limited to such examples. For example, at least some of the processes performed by the image processing apparatus 120 may be performed by a different device. In addition, the processes in the image processing system 100 according to the exemplary embodiment discussed above are exemplary, and may be reordered unless any contradiction occurs.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The present disclosure may be provided as a program to be executed by each of the image processing apparatus 120 and the wearable terminal 110. The image processing apparatus 120 and the wearable terminal 110 are each an example of the computer according to the present disclosure. The program may be downloaded via a communication line such as the Internet, and may be provided as recorded in a computer-readable recording medium such as a magnetic recording medium (such as a magnetic tape and a magnetic disk), an optical recording medium (such as an optical disc), a magneto-optical recording medium, and a semiconductor memory.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing apparatus comprising:
a processor,
wherein the processor is configured to:
when a specific process is started by an operation of a user, acquire first biological information on the user,
during execution of the specific process, acquire second biological information on the user,
when the specific process is completed, acquire third biological information on the user,
determine, using the first, second, and third biological information, whether the user is in an anxious psychological state with respect to the specific process, and
in response to determining that the user is in the anxious psychological state with respect to the specific process, output information that indicates a detailed content of the specific process.

2. The information processing apparatus according to claim 1, wherein the processor is configured to:
in outputting the information,
output first information having a first level of detail of the specific process in a case where it is determined that the user is in a slight anxious state, and
output second information having a second level of detail of the specific process in a case where it is determined that the user is in a severe anxious state.

3. The information processing apparatus according to claim 2,
wherein the second information includes a larger amount of information than the first information.

4. The information processing apparatus according to claim 2, wherein
the first information indicates a result of the specific process, and
the second information includes an operation image that is used for an operation to change the result of the specific process.

5. The information processing apparatus according to claim 1, wherein the processor does not output the information that indicates the detailed content of the specific process in a case where the first and second biological information indicates the anxious psychological state before the specific process is completed.

6. A non-transitory computer readable medium storing a program causing a computer to execute a process comprising:
when a specific process is started by an operation of a user, acquiring first biological information on the user; and
during execution of the specific process, acquire second biological information on the user,
when the specific process is completed, acquire third biological information on the user,
determine, using the first, second, and third biological information, whether the user is in an anxious psychological state with respect to the specific process, and
in response to determining that the user is in the anxious psychological state with respect to the specific process, outputting information that indicates a detailed content of the specific process.

7. An information processing apparatus comprising:
means for acquiring first biological information on a user when a specific process is started by an operation of the user,
means for acquiring second biological information on the user during execution of the specific process,
means for acquiring third biological information on the user when the specific process is completed,
means for determining, using the first, second, and third biological information, whether the user is in an anxious psychological state with respect to the specific process, and
means for outputting information that indicates a detailed content of the specific process in response to determining that the user is in the anxious psychological state with respect to the specific process.

8. The information processing apparatus according to claim 1, wherein
the specific process that triggers acquisition of the first, second and third biological information includes a facsimile process and a setting change process on the information processing apparatus.

9. The information processing apparatus according to claim 1, wherein
when the specific process is a facsimile process, and the user is determined to be anxious with respect to the specific process using the first, second, and third biological information, the information that is outputted to relieve the user's anxiety includes at least one of a transmission destination number, a transmission date, a transmission time, and a transmission result.

10. The information processing apparatus according to claim 1, wherein
when the specific process is a setting change process, and the user is determined to be anxious with respect to the specific process using the first, second, and third biological information, the information that is outputted to relieve the user's anxiety includes both a changed setting and an operator for further changing the setting.
